(19) United States
(12) Patent Application Publication
(10) Pub. No.: US 2014/0278235 A1
(43) Pub. Date: Sep. 18, 2014

(54) SCALABLE MESSAGE PASSING FOR RIDGE REGRESSION SIGNAL PROCESSING

(71) Applicant: Board of Trustees, Southern Illinois University, Carbondale, IL (US)

(72) Inventors: Hongbo Zhou, Westmont, IL (US); Qiang Cheng, Carbondale, IL (US)

(73) Assignee: BOARD OF TRUSTEES, SOUTHERN ILLINOIS UNIVERSITY, Carbondale, IL (US)

(21) Appl. No.: 14/209,323

(22) Filed: Mar. 13, 2014

Related U.S. Application Data
(60) Provisional application No. 61/788,107, filed on Mar. 15, 2013.

(51) Int. Cl. G06F 17/18

(52) U.S. Cl. CPC G06F 17/18
USPC 702/179

(57) ABSTRACT

An apparatus and method for a design for a computer implemented message passing methodology for solving the ridge regression that is faster, more accurate, and more efficient, and is also globally convergent, meaning it becomes more accurate with each step, ultimately reducing its margin of error to zero.

### CROSS-REFERENCE TO RELATED APPLICATIONS

This application claims the benefit of and priority to U.S. Provisional Application Ser. No. 61/788,107, Filed Mar. 15, 2013 and entitled SCALABLE MESSAGE PASSING FOR RIDGE REGRESSION and is incorporated herein in its entirety.

### BACKGROUND OF INVENTION

1. Field of Invention

This invention relates generally to ridge regression and, more particularly, to methodology for ridge regression.

2. Background Art

Multiple linear regression is one of the most widely used of all statistical methods. It is used by data analysts in nearly every field of science and technology as well as the social sciences, economics, and finance. Today it is a rare computer center that does not have a general purpose program of some kind to perform the standard calculations. But, as has been shown in the estimation of regression coefficients can present problems when the data vectors for the predictors are not orthogonal. In particular, the number of coefficients tend to be large and it is possible that some will even have the wrong sign, and the probability of such difficulties increases the more the prediction vectors deviate from orthogonality.

Y=Xβ+ε

Where E[ε]=0, E[ε ε^{T}]=σ²Iₙ and X is (n×p) and full rank. Let

̂β=(X^{T}X)⁻¹X^{T}Y

be the orthogonal least squares estimate of β

There are at least two reasons for introducing Ridge regression: a) even when X′*X is invertible, the coefficients are very sensitive to some perturbations (to the data matrix X); b) most often, X′*X is not invertible, it is necessary to introduce a non-trivial diagonal matrix to make X′*X invertible. Ridge regression is an estimation procedure based upon

̂β*=(X^{T}X+K)⁻¹X^{T}Y

where K is a diagonal matrix of non-negative constants. A useful procedure uses K=kIₚ, k>0.

The first is the RIDGE TRACE which is a two-dimensional plot of the ̂β*.

i(k) and the residual sum of squares, φ*(k), for a number of values of k in the interval [0, 1]. The trace serves to portray the complex interrelationships that exist between non-orthogonal prediction vectors and the effect of these interrelationships on the estimation of β. The second aspect is the determination of a value of k that gives a better estimate of β by dampening the effect.”

Ridge regression, or Tikhonov regularization, is the most commonly used statistical parameter estimation method for ill-posed problems. Introduced upon a solid mathematical foundation, it has numerous applications in conventional signal processing areas such as radar, sonar, seismology, wireless communications, radio astronomy, acoustics, navigation, biomedicine, etc. Also, it has been widely used in various emerging data mining applications. Although the ridge regression has an explicit form of solution, its application is also limited because its explicit solution involves matrix inversion operations, which are computationally forbidden or not practical for large-scale datasets. All prevailing statistical data analysis or signal processing software has their own built-in algorithms and implementations for the ridge regression.

Ridge regression is a form of regression analysis in which damping factors are added to the diagonal of the correlation matrix prior to inversion, a procedure which tends to orthogonalize interrelated variables. Ridge Regression is the study of the robustness of the regression coefficients with changes in the damping factors is then used to determine sets of variables that should be removed. Also known as damped regression analysis.

Ridge Regression is a remedial measure that can be taken to alleviate multicollinearity or collinearity amongst regression predictor variables in a model. Collinearity is a property of a set of points, specifically, the property of lying on a single line. A set of points with this property is said to be collinear. Generally, the term has been used for aligned objects, that is, things being “in a line” or “in a row”. In statistics collinearity can refer to an exact or approximate linear relationship between two explanatory variables multicollinearity extends the concept to more than two explanatory variables, and lateral collinearity expands the concept still further. Often predictor variables used in a regression are highly correlated. When they are, the regression coefficient of any one variable may depend on which other predictor variables are included in the model, and which ones are left out. The predictor variable does not reflect any inherent effect of that particular predictor on the response variable, but only a marginal or partial effect, given whatever other correlated predictor variables are included in the model. Ridge regression can add a small bias factor to the variables in order to alleviate this problem.

Given that Ridge regression is a variant of ordinary linear regression, whose goal is to circumvent possible collinearity of the predictors, that is, when the design matrix is not invertible. This method can be viewed as artificially modifying the design matrix so as to make its determinant “sufficiently” different from 0. This modification causes the estimator to be biased (as opposed to the RSS estimator), but significantly reduces the variance of the estimator.

However, for large data sets, ridge regression is not computationally practical due to the requirement for matrix inversion and other known factors. The computational complexity of ridge regression methods given the quadratic or cubic computations required for matrix inversion combined with handling large data set often make ridge regression techniques impractical.

### BRIEF SUMMARY OF INVENTION

Disclosed herein is a design for a computer implemented message passing methodology for solving the ridge regression. The computer implemented program is faster, more accurate, and more efficient than those already in existence. It is also globally convergent, meaning it becomes more accurate with each step, ultimately reducing its margin of error to zero. The technology disclosed and claimed herein is a methodology for handling large scale data sets relating to a signal or other information whether image data, statistical data or otherwise, where ridge regression would ordinarily be impractical to regularize such large scale data sets.

Given a real-valued data matrix A of M row and n columns, a real-valued column vector y of length m, and a non-negative real-valued penalization weight λ, this design aims at computing \hat{x} based on the following ridge regression formulation

\hat{x}=minₓ∥y−Ax∥₂²+λ∥x∥₂². [1-6]:

As we discussed yesterday, we will formally provide definitions for all the variables.

1. Explanation \hat{x} and the Formulation:

Here \hat{x} is a vector of real values. Its size is n×1. It linearly combines all the columns of the data matrix A to approximate a given column vector y which is of size m×1. There can be infinitely many such vectors for linearly combining the columns of data matrix A to approximate y, but \hat{x} is an optimal vector for this linear approximation in the sense that it minimizes the approximation error which is the sum of squared differences of the approximation given by ∥y−Ax∥₂², and a quantity measuring the complexity (or the size) of the combining coefficients, given by λ∥x∥₂².
Here A is a nonnegative real value balancing the approximation error and the complexity measure.

For a given tolerance level ε>0 and an initialization estimation of solution x⁰=A^{T}y, this design mainly consists of the following steps:
a) Compute the reweight factor RF=∥A∥₂, where ∥A∥₂ is the Frobenius norm of matrix A. If ×n>10³, to speed up the norm computation, we compute RF as the estimated Frobenius norm using the power iteration method.
b) If RF>1, compute the reweighted data

$$y ← \frac{y}{RF} , λ ← \frac{λ}{RF} , A ← \frac{A}{RF} .$$

c) Repeat the following iteration from t=0,

$${x}^{t + 1} ← \frac{{x}^{t} + {A}^{T} ( y - {Ax}^{t} )}{1 + λ} ,$$

unless ∥x^{t+1}−x^{t}∥<ε.
d) Take \hat{x}←x^{t+1} as the solution.
   The computation involves only matrix-vector multiplications, and the complexity for each iteration is O(mn). This algorithm is proved to be globally convergent.
   The integer t represents the t_th iteration, and x^{t} represents the value of x at the t_iteration. The iterative regression function provides a formula to calculate the value of x at the (t+1)_th iteration based on the previous value of x at the t_iteration. This process will be repeated until the stopping criterion of ∥x^{t+1}+x^{t}∥<ε is satisfied.
   When this stopping criterion is met, \hat{x} will be assigned to a value which is simply the current value of the iteration, i.e., x^{t+1}.

Two sets of experiments can be utilize to verify the methodology disclosed herein by comparing this design disclosed herein (MPA) with a standard strict convex programming package (CVX) and MathWorks' implementation of ridge regression (Matlab built-in function). Both of them are widely used optimization/statistical software. The first experiment is of medium size which is restricted by CVX solvers. A sparse signal y of m=2000 is generated, and then 3000 random observations are generated, the size of A is 3000 by 2000. Given the same setting λ=1, precision or tolerance level ε 1e-5, and maximum iteration 1000 for all methods, FIG. 1 shows the compared results for CVX, Matlab, and MPA on the same dataset. The blue signals are recovered by CVX. The top row shows the recovered signals from CVX (blue) and MPA (red), and the bottom row shows recovered signals from CVX (blue) and Matlab (red). On this dataset, MPA is 40 times faster than the CVX while the difference in accuracy is 0.00069337; MPA is 25 times more accurate than Matlab's implementation while MPA is two times more efficient than Matlab.

Without the limitation of CVX, the second experiment is designed to compare the efficiency between MPA and Matlab on large-scale datasets. A sparse signal y of m=3000 is generated, and then 5000 random observations are generated, the size of A is 3000 by 2000. Given the same setting A=1, precision or tolerance level ε 1e-5, and maximum iteration 1000 for all methods, FIG. 2 shows the compared results for Matlab and MPA. The blue signals are recovered by Matlab, and the red signals are recovered by MPA. On this dataset, MPA is five times faster than the Matlab's built-in ridge function while the difference between their solutions is only 0.015612, which is mainly caused by the inaccuracies of the Matlab built-in ridge function.

Potential applications include, but are not limited to a basic built-in block for various statistical/numerical software, such as CVX, MATLAB, MATHEMATICS, SAS, SPSS, etc. Some potential customers include companies developing numerical/statistical software algorithms/packages. Further applications are ridge regression signal processing for position-fix navigation systems; and regression-based object detection in medical images.

This technology is a computer implemented program with a new methodology used to solve an existing equation. Essentially, it is a fast way of computing large numbers, and it can be used in a wide variety of applications. The invention is a building block with many different possible uses. The program is faster, more accurate, and more efficient than those already in existence. It is also the only program of its kind that is globally convergent, meaning it becomes more accurate with each step, ultimately reducing its margin of error to zero. The technology has a wide variety of applications. It will be most beneficial to the military/defense, navigational, medical, and financial fields. However, it is capable of being used in many more fields for various purposes. The program (labeled “MPA”) is faster, more accurate, and more efficient than any known, preexisting program. This creates near real time results, thereby allowing for less error. MPA is also better at scaling (handling greater numbers). It is adaptable and open for future possibilities, including integration and app development, and the computer implemented program is user-friendly. MPA scales better than other competing methodologies, meaning it is better at handling more numbers. Although MPA is faster and more accurate than others, its significance comes primarily when the size of the factor is bigger. Other applications slow down exponentially as the numbers increase, whereas MPA is more consistent. MPA converges to the correct solution by becoming more accurate as it goes through each step of the equation, ultimately achieving an error margin of zero by the completion of the process.

As described above, MPA could be used for various applications from statistics to navigational systems (allowing ground troops, aircrafts, watercrafts, vehicles of any sort, and the ammunitions used by/on the aforementioned things to more accurately identify their current location and their target location). This technology allows for near real time and more accurate results in calculating the distance and location. Another major field to consider is the medical field. Upon scanning images of, for example, the brain, MPA provides the doctor with faster and better display images and more control over the movement of those images. Yet another major field to consider in regards to MPA is the financial field. MPA can provide more accurate data on the number of stocks a purchaser should buy based on the price. Other fields to consider would be the shipping industry, economic field, and marketing.

MPA can be integrated for use with computer implemented programs such as JAVA, COM, and Microsoft Excel. MPA is already user-friendly and could easily be adapted for application (app) development. A few examples include GPS phone apps, tablet apps catered towards stock brokers, and statistical apps for curious and bored consumers.

The computer implemented technology as disclosed and claimed provides the scalability that is required for the operation to have a linear computational complexity. Therefore, a statistical parameter estimation methodology for ill-posed problems having large-scale data sets becomes practical when using the technology as disclosed and claimed herein. The explicit solution of ridge regression involves matrix inversion (or pseudo-inversion) which is quadratic or cubic (depending on your algorithm for Singular Value Decomposition (SVD)) in terms of computational complexity. Convex solvers (CVX) or many prior exact methods adopt variants of matrix inversion or SVD algorithms to approach this problem and thus they are not scalable. The disclosed technology only involves matrix-vector multiplication, which has a linear computational complexity and thus it is scalable. When implementing the technology as disclosed and claimed the original ridge regression problem is broken into a series of simple algebraic iterations. Each iteration only involves matrix-vector multiplication. The methodology has been proven such that the solutions of these simple iterations converge to the solution of original ridge regression.

These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIG. 1 is a computing system;

FIG. 2 is a flow diagram;

FIG. 3 is an illustration of the performance comparison of CVX, Matlab and MPA;

FIG. 4 is an illustration of the performance comparison of Matlab and MPA; and

FIG. 5 is an illustration of the performance comparison of Matlab and MPA.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF INVENTION

According to the embodiment(s) of the present invention, various views are illustrated in FIG. 1-5 and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

Referring to FIG. 4, a computing system 100 is shown. By way of illustration, users 110, 112, can access via client computers 104, 106, a server's 114 computing and processing capability over a local or wide area network 201; or the entire computing system and client can reside on one computer or server having a user interface. The server 114 can access and execute the matrix build and regression engine 118 and the user interface application and having access to signal data 116 on which to operate. The MPA Regression Application 122 can be accessed and executed to perform the MPA regression methodology.

Referring to FIG. 5, a flow diagram of the MPA methodology is shown. The steps performed include receiving at a computer system an input of data for a matrix A of m rows and n columns, where the matrix A is a real-valued data matrix A of m row and n columns, and where a real-valued column vector y of length m, and a non-negative real-valued penalization weight A, and for a given tolerance level ε>0 and an initialization estimation of solution x⁰=A^{T}y, where the matrix is designed for computing ̂x based on the regression formulation 502; computing the reweight factor RF, where the solution is the Frobenius norm of matrix A 504; if the number of columns n is greater than 10³, then computing RF as the estimated Frobenius norm using the power iteration method; if RF greater than 1, computing the reweighted data; and Repeat the iteration from t=0 506; computing the reweight factor 508; and computing RF as the estimated Frobenius norm using the power iteration method, and if RF>1, computing the reweighted data.

One embodiment of the present methodology is a computer implemented method for ridge regression of data comprising the steps of receiving at a computer system an input of data for a matrix A of m rows and n columns, a real-valued column vector y of length m, and a non-negative real-valued penalization weight λ; where the matrix is designed for computing \hat{x} based on the regression formulation of

\hat{x}=minₓ∥y−Ax∥₂²+λ∥x∥₂²

Computing the reweight factor RF, where the solution is the Frobenius norm of matrix A; if the number of columns n is greater than 10³, then computing RF as the estimated Frobenius norm using the power iteration method; if RF greater than 1, computing the reweighted data; and Repeat the following iteration from t=0,

$${x}^{t + 1} ← \frac{{x}^{t} + {A}^{T} ( y - {Ax}^{t} )}{1 + λ} ,$$

unless ∥x^{t+1}−x^{t}∥<ε.

Given a real-valued data matrix A of m row and n columns, a real-valued column vector y of length m, and a non-negative real-valued penalization weight λ,

For a given tolerance level ε>0 and an initialization estimation of solution x⁰=A^{T}y, this design mainly consists of the following steps:

Compute the reweight factor RF=∥A∥₂, where ∥A∥₂ is the Frobenius norm of matrix A. If ×n>10³, to speed up the norm computation, compute RF as the estimated Frobenius norm using the power iteration method.

If RF>1, compute the reweighted the data

$$y ← \frac{y}{RF} , λ ← \frac{λ}{RF} , A ← \frac{A}{RF} .$$

Repeat the following iteration from t=0,

$${x}^{t + 1} ← \frac{{x}^{t} + {A}^{T} ( y - {Ax}^{t} )}{1 + λ} ,$$

unless ∥x^{t+1}−x^{t}∥<ε.

Take \hat{x}←x^{t+1} as the solution.

The computation involves only matrix-vector multiplications, and the complexity for each iteration is O(mn). This algorithm is globally convergent.

TABLE 1
General notation:

| Variable | Type | Meaning |
|---|---|---|
| m | Positive integer | Use to denote the dimensionality of |
| | | each example in the ridge regression |
| | | problem or the number of rows in |
| | | the data matrix. |
| n | Positive integer | Use to denote number of examples |
| | | in the ridge regression problem or |
| | | the number of columns in the data |
| | | matrix. |

TABLE 2
Input variables:

| Variable | Type | Meaning |
|---|---|---|
| Y | column vector of length | Use to denote a test example |
| | m, each element is a real- | in the ridge regression |
| | value number | problem. |
| A | Matrix, m row and n | Use to denote the collection of |
| | columns. | examples, where each column |
| | | is an example |
| λ | non-negative real-value | Use as a weight in the ridge |
| | number | regression problem to balance |
| | | the approximation error |
| | | \|\|y − Ax\|\|₂² and the |
| | | complexity measure \|\|x\|\|₂² |

TABLE 3
Output variables:

| Variable | Type | Meaning |
|---|---|---|
| x | column vector of length | Use to denote the |
| | n, each element is a real- | computed ridge regression |
| | value number | coefficient vector, our |
| | | results. |

TABLE 4
Intermediate variables:

| Variable | Type | Meaning |
|---|---|---|
| x | column vector of length n, | Use to denote a coefficient |
| | each element is a real-value | vector |
| | number | |
| x⁰ | column vector of length | Use to denote an |
| | n, each element is a real- | initialization vector of the |
| | value number | ridge regression results. |
| t | A positive integer | Denote the t-th iteration |
| x^{t} | column vector of length | Use to denote an |
| | n, each element is a real- | intermediate result of |
| | value number | ridge regression after t-th |
| | | iteration |
| ε | non-negative real-value | Use as the tolerance level to |
| | number | check the convergence |
| | | criterion in our algorithm. |
| RF | Reweight factor RF = | An intermediate variable |
| | \|\|A\|\|₂, where \|\|A\|\|₂ is the | used in the iterative |
| | Frobenius norm of matrix A | procedure. |

Two set of experiments can be utilize to verify the methodology disclosed herein by compare this design disclosed herein (MPA) with a standard strict convex programming package (CVX) and MathWorks' implementation of ridge regression (Matlab built-in function). Both of them are widely used optimization/statistical software. The first experiment is of medium size which is restricted by CVX solvers. A sparse signal y of m=2000 is generated, and then 3000 random observations are generated, the size of A is 3000 by 2000. Given the same setting A=1, precision or tolerance level ε 1e-5, and maximum iteration 1000 for all methods, FIG. 1 shows the compared results for CVX, Matlab, and MPA. On this dataset, MPA is 40 times faster than the CVX while the difference in accuracy is 0.00069337; MPA is 25 times more accurate than Matlab's implementation while MPA is two times more efficient than Matlab, which mainly consists of the inaccuracies from the Matlab built-in ridge function.

Without the limitation of CVX, the second experiment is designed to compare the efficiency between MPA and Matlab on large-scale datasets. A sparse signal y of m=3000 is generated, and then 5000 random observations are generated, the size of A is 3000 by 2000. Given the same setting A=1, precision or tolerance level ε 1e-5, and maximum iteration 1000 for all methods, FIG. 2 shows the compared results for Matlab and MPA. On this dataset, MPA is five times faster than the Matlab's built-in ridge function while the difference between their solutions is only 0.015612.

Referring to FIG. 3, an illustration of the performance comparison of Matlab and MPA. The blue signals are recovered by Matlab while the red are recovered by MPA. The parameters are: 1000 variable, 6000 observations, and 500 spikes. All other parameters are the same as for the other illustrations. For this dataset, MPA is about 10 times faster than Matlab's ridge function.

The following are examples of how the technology disclosed and claimed herein can be utilized to operate on large scale data sets that are representative of a signal or other information embodied in a large scale data set.

1. Inferring Invisible Traffic
Problem Statement:
It is an important technique to infer “traffic information or estimating total volume of traffic/data flowing through a target network/entity, wherein only a partial subset of inferred traffic information or volume of data is available to a predictor entity/network that infers such traffic information. In an embodiment, such partial subset of total traffic can either be made available to the entity/network for inferring and estimating total traffic or such partial data can actually flow through the entity/network.” [“System and method for inferring invisible traffic,” US20130304692, Vineet Bharti, Pankaj Kankar, Anukool Lakhina, Applied by Guavus Network Systems Pvt. Ltd.]
The importance: “Many of the decisions that Internet Protocol network operators make depend on how the traffic flows in and through their network. When used together with routing information, information on how the traffic flows across networks gives network operators valuable information about the current network state, which can be instrumental in traffic engineering, network management, provisioning, and making important business decisions.” [“System and method for inferring invisible traffic,” US20130304692, Vineet Bharti, Pankaj Kankar, Anukool Lakhina, Applied by Guavus Network Systems Pvt. Ltd.]
How the method will be used in such as problem:
First step:
Assume that “group X comprises of rows and columns having known values, and group y comprises of multiple rows having known values and a single column having the traffic element to be estimated, further model parameter β is computed through relationship of y=Xβ.” [System and method for inferring invisible traffic,” US20130304692, Vineet Bharti, Pankaj Kankar, Anukool Lakhina, Applied by Guavus Network Systems Pvt. Ltd.]
Use ridge regression to estimate the model parameter β.
Second step:
Assume “model inputs A are traffic matrix elements visible to said predictor network;” incorporate “model parameters 13 based on predictors rows and predictor columns of said traffic matrix elements visible to said predictor network; and linearly estimating traffic elements z of said a target network based on said model inputs A and said model parameters β.” [System and method for inferring invisible traffic, US20130304692, Vineet Bharti, Pankaj Kankar, Anukool Lakhina, Applied by Guavus Network Systems Pvt. Ltd.]
That is, z=Aβ.

The regression computer implement application can be accessed and executed to perform the MPA regression methodology. The steps can include receiving at a computer system an input of data for a matrix, where the matrix is a real-valued data matrix of m row and n columns, and where a real-valued column vector of length m, and a non-negative real-valued penalization weight, and for a given tolerance level ε>0 and an initialization estimation of solution, where the matrix is designed for computing the ridge regression coefficient vector based on the regression formulation; computing the reweight factor, where the solution is the Frobenius norm of matrix A and if the number of columns n is greater than 10³, computing the reweight factor as the estimated Frobenius norm using the power iteration method; if the reweight factor is greater than 1, computing the reweighted data; and repeat the iteration from t=0; computing the reweight factor; and computing reweight factor as the estimated Frobenius norm using the power iteration method, and if the reweight factor is >1, computing the reweighted data. The data in the matrix received at a computing system having store thereon executable instructions for implementing MPA includes data traffic information where the computing system is to infer traffic information or estimate total volume of traffic/data flowing through a target network/entity, wherein only a partial subset of inferred traffic information or volume of data is available to a predictor entity/network that infers such traffic information.

2. Accurate Labeling of Patient Records According to Diagnoses and Procedures that Patients have Undergone
Problem Statement:
“Medical coding is best described as a translation from an original language in medical documentation regarding diagnoses and procedures related to a patient into a series of code numbers that describe the diagnoses or procedures in a standard manner. Medical coding influences which medical services are paid, how much they should be paid and whether a person is considered a “risk” for insurance coverage. Medical coding is an essential activity that is required for reimbursement by all medical insurance providers. It drives the cash flow by which health care providers operate. Additionally, it supplies critical data for quality evaluation and statistical analysis. In order to be reimbursed for services provided to patients, hospitals need to provide proof of the procedures that they performed. Currently, this is achieved by assigning a set of CPT (Current Procedural Terminology) codes to each patient visit to the hospital. Providing these codes is not enough for receiving reimbursement: in addition, hospitals need to justify why the corresponding procedures have been performed. In order to do that, each patient visit needs to be coded with the appropriate diagnosis that require the above procedures.” [System and Method for Large Scale Code Classification for Medical Patient Records, US 20080288292 A1, Jinbo Bi, Lucian Vlad Lita, Radu Stefan Niculescu, R. Bharat Rao, Shipeng Yu, Applied by Siemens Medical Solutions USA, Inc.]
The importance: “The coding approach currently used in hospitals relies heavily on manual labeling performed by skilled and/or semi-skilled personnel. This is not only a time consuming process, but also very error-prone given the large number of ICD-9 codes and patient records. This can be partly explained by the fact that coding is done by medical abstractors who often lack the medical expertise to properly reach a diagnosis. Two situations frequently occur: “over-coding”, which is assigning a code for a more serious condition than is justified, and “under-coding”, which refers to missing codes for existing procedures/diagnoses. Both situations translate into financial loses for insurance companies in the first case and for hospitals in the second case.”
“Accurate coding is important because ICD9 codes are widely used in determining patient eligibility for clinical trials as well as in quantifying hospital compliance with quality initiatives. Some studies show that only 60% to 80% of the assigned ICD-9 codes reflect the exact patient medical diagnosis. Furthermore, variations in medical language usage can be found in different geographic locales, and the sophistication of the term usage also varies among different types of medical personnel. Therefore, an automatic medical coding system would be useful and would not only speed up the process, but also improve coding accuracy.” [System and Method for Large Scale Code Classification for Medical Patient Records, US 20080288292 A1, Jinbo Bi, Lucian Vlad Lita, Radu Stefan Niculescu, R. Bharat Rao, Shipeng Yu, Applied by Siemens Medical Solutions USA, Inc.]

How the method will be used in such as problem:
“Suppose there is a sample set of pairs (xᵢ; yⁱ); i=1, . . . , N, where xᵢεR^{d} is the i^{-th} feature vector and yᵢε{+1, −1} is the corresponding label. Denote XεR^{N×d} as the feature matrix whose i^{-th} row contains the features for the i^{-th} data point, and y the label vector of N labels. The conventional linear ridge regression constructs a hyperplane-based function w^{T}x to approximate the output y by minimizing the following loss function” [System and Method for Large Scale Code Classification for Medical Patient Records, US 20080288292 A1, Jinbo Bi, Lucian Vlad Lita, Radu Stefan Niculescu, R. Bharat Rao, Shipeng Yu, Applied by Siemens Medical Solutions USA, Inc.]
An Example Problem: “In the experiments described herein the notes for each patient visit were combined to create a hospital visit profile that is defined to be an individual document. The corpus extracted from the patient database contains diagnostic codes for each individual patient visit, and therefore for each of our documents. A 1.3 GB corpus using medical patient records was extracted from a real single-institution patient database. This is useful since most published previous work was performed on very small datasets. Due to privacy concerns, since the database contains identified patient information, it cannot be made publicly available. Each document contains a full hospital visit record for a particular patient. Each patient may have several hospital visits, some of which may not be documented if they choose to visit multiple hospitals. This dataset contains 96,557 patient visits, each labeled with a one or more ICD-9 codes. There are 2618 distinct ICD-9 codes associated with these visits”. [2] “Prior to training the classifiers on the dataset, feature selection was performed using χ². The top 1,500 features with the highest χ² values were selected to make up the feature vector.”
That is, N=96,557, d=1500. And the ridge regression has to be run for 2618 times (for each of the ICD-9 codes, a regression is needed). In each regression, a matrix of size N×N=96557×96557 needs to be inverted.
More specifically,
First step:

L_{RR}(w)=minimize_{—}w∥y−Xw∥²+λ∥w∥²
Use ridge regression to estimate the model parameter w.
Second step:
For a new patient with a feature vector of zεR^{d}, estimate the coding with w^{T}z. If the value is negative then the coding is −1; otherwise, +1.
Since “it would be helpful to have different weights for different observations such that the costs of mislabeling are different”, the extension from ridge regression to weighted ridge regression is straightforward, which needs to solve the following minimization problem:

(y−Xw)^{t}A(y−Xw)+λ∥w∥².
The closed form solution for optimal w is:

(X^{T}AX+λI)⁻¹X^{T}Ay.

The regression computer implement application can be accessed and executed to perform the MPA regression methodology. The steps can include receiving at a computer system an input of data for a matrix, where the matrix is a real-valued data matrix of m row and n columns, and where a real-valued column vector of length m, and a non-negative real-valued penalization weight, and for a given tolerance level ε>0 and an initialization estimation of solution, where the matrix is designed for computing the ridge regression coefficient vector based on the regression formulation; computing the reweight factor, where the solution is the Frobenius norm of matrix A and if the number of columns n is greater than 10³, computing the reweight factor as the estimated Frobenius norm using the power iteration method; if the reweight factor is greater than 1, computing the reweighted data; and repeat the iteration from t=0; computing the reweight factor; and computing reweight factor as the estimated Frobenius norm using the power iteration method, and if the reweight factor is >1, computing the reweighted data. The data in the matrix received at a computing system having store thereon executable instructions for implementing MPA includes medical record coding information where the computing system is to determine reimbursement and insurance coverage, wherein only a partial subset of the coding information is available or incorrectly coded.

3. Predicting Unobserved Phenotypes
Problem Statement: “The presently disclosed subject matter relates to molecular genetics and plant breeding. In some embodiments, the presently disclosed subject matter relates to methods for predicting unobserved phenotypes for quantitative traits using genome-wide markers across different breeding populations.” [Methods and compositions for predicting unobserved phenotypes, EP 2577536 A2, Zhigang Guo, Venkata Krishna Kishore, Applied by Syngenta Participations AG]
Background:
“A goal of plant breeding is to combine, in a single plant, various desirable traits. For field crops such as corn, these traits can include greater yield and better agronomic quality. However, genetic loci that influence yield and agronomic quality are not always known, and even if known, their contributions to such traits are frequently unclear.” [Methods and compositions for predicting unobserved phenotypes, EP 2577536 A2, Zhigang Guo, Venkata Krishna Kishore, Applied by Syngenta Participations AG]
“Once discovered, however, desirable genetic loci can be selected for as part of a breeding program in order to generate plants that carry desirable traits. An exemplary approach for generating such plants includes the transfer by introgression of nucleic acid sequences from plants that have desirable genetic information into plants that do not by crossing the plants using traditional breeding techniques.” [Methods and compositions for predicting unobserved phenotypes, EP 2577536 A2, Zhigang Guo, Venkata Krishna Kishore, Applied by Syngenta Participations AG]
“However, even when the traits are known and suitable parental plants carrying the traits are available, producing progeny plants that have desirable combinations of the genetic loci associated with the traits can be a very long and expensive process.” [Methods and compositions for predicting unobserved phenotypes, EP 2577536 A2, Zhigang Guo, Venkata Krishna Kishore, Applied by Syngenta Participations AG]
“What are needed, then, are new methods and compositions for genetically and phenotypically analyzing plants, and for employing the information obtained for producing plants that have traits of interest.” [Methods and compositions for predicting unobserved phenotypes, EP 2577536 A2, Zhigang Guo, Venkata Krishna Kishore, Applied by Syngenta Participations AG]
How the method will be used in such as problem:
Two critical steps need to use ridge regression:
A. “determining marker effects for a plurality of markers in a genotyped and phenotyped reference population with respect to a phenotype.” [3]
B. “predicting a phenotype of the one or more plants of the predicted population based on the sum of the marker effects.” [Methods and compositions for predicting unobserved phenotypes, EP 2577536 A2, Zhigang Guo, Venkata Krishna Kishore, Applied by Syngenta Participations AG]
“The determining step comprises estimating the marker effects for each of the plurality of markers by ridge regression-best linear unbiased prediction (RR-BLUP).” [Methods and compositions for predicting unobserved phenotypes, EP 2577536 A2, Zhigang Guo, Venkata Krishna Kishore, Applied by Syngenta Participations AG]
“Predicting step comprises employing a linear model for ridge regression-best linear unbiased prediction (RR-BLUP).” [Methods and compositions for predicting unobserved phenotypes, EP 2577536 A2, Zhigang Guo, Venkata Krishna Kishore, Applied by Syngenta Participations AG]

The regression computer implement application can be accessed and executed to perform the MPA regression methodology. The steps can include receiving at a computer system an input of data for a matrix, where the matrix is a real-valued data matrix of m row and n columns, and where a real-valued column vector of length m, and a non-negative real-valued penalization weight, and for a given tolerance level ε>0 and an initialization estimation of solution, where the matrix is designed for computing the ridge regression coefficient vector based on the regression formulation; computing the reweight factor, where the solution is the Frobenius norm of matrix A and if the number of columns n is greater than 10³, computing the reweight factor as the estimated Frobenius norm using the power iteration method; if the reweight factor is greater than 1, computing the reweighted data; and repeat the iteration from t=0; computing the reweight factor; and computing reweight factor as the estimated Frobenius norm using the power iteration method, and if the reweight factor is >1, computing the reweighted data.

The data in the matrix received at a computing system having store thereon executable instructions for implementing MPA includes data relating to genome-wide markers for quantitative traits where the computing system is to determine marker effects on positive traits and is used to predict a phenotype of the one or more plants of the predicted population based on the sum of the marker effects

4. Customer Cognitive Style Prediction Model Based on Mobile Behavioral Profile
Problem Statement: “predicting user cognitive and personality profiles for every customer of a telecom operator, and more particularly to a method that uses customers' behavioral information extracted directly from the operator's records in order to compute values of cognitive and personality indicators of a multi-dimensional vector.” [Customer cognitive style prediction model based on mobile behavioral profile, US 20120284080 A1, Rodrigo De Oliveira, Ana ARMENTA, Pedro CONCEJERO, Cesar Martin GUERRA-SALCEDO, Alexandros KARATZOGLOU, Nuria Oliver, Ruben LARA]
Background:
“A key asset of a telecommunications operator is the knowledge that it has about its customers. Having deep customer knowledge allows the operator to optimize the relationship with its customers, and increase customer satisfaction by means of, e.g., personalized services or attractive commercial offerings. In addition, this focus on the customers will enable the operator to maintain sustainable leadership in such a mature and competitive market.
One important piece of information about the customers is their personality and psychological profile. Until now, the knowledge that a telecommunications provider has about personality traits and its customers' psychological profile has been exclusively obtained from market research studies, usually carried out by means of surveys. Surveys typically require a huge amount of time and resources, are not easily scalable, and depend on the particular scope of the study and the context when the survey or market research is done. In addition, uncertainty and biases are introduced by well-known facts like social desirability in the responses, turning it very difficult, if not impossible, to infer values in psychological dimensions for all customers.
A telecommunications provider has a vast amount of information about its customers' communication behavior, including the customers' social networks. Therefore, there is a lot of data about “what customers do”, but there is little, if anything, about “why customers do what they do”. [Customer cognitive style prediction model based on mobile behavioral profile, US 20120284080 A1, Rodrigo De Oliveira, Ana ARMENTA, Pedro CONCEJERO, Cesar Martin GUERRA-SALCEDO, Alexandros KARATZOGLOU, Nuria Oliver, Ruben LARA]
How Ridge Regression is used in this problem:
A. Extracting Customer Behavioral Data: “The operator's available customer usage data are extracted to be used as input of the models. These data include, but are not limited to:
1. Call Detail Records (CDRs): hundreds of variables (408 in an implementation of this invention) that summarize every customer's mobile phone usage are computed from the CDR available in the operator's data warehouse. Definition of the summary usage variables (time ranges—ranges of hours for computing summaries of voice calls, SMS and MMS usage) as well as ratios are property of the operator.
2. Social Network Analysis variables are also stored in the operator's data warehouse.
3. Additional variables that are available in the operator's data warehouse and commercial information databases shall be transformed and operationalized to be used as inputs of the predictive models” [Customer cognitive style prediction model based on mobile behavioral profile, US 20120284080 A1, Rodrigo De Oliveira, Ana ARMENTA, Pedro CONCEJERO, Cesar Martin GUERRA-SALCEDO, Alexandros KARATZOGLOU, Nuria Oliver, Ruben LARA]
These variables will be put into a matrix X.
B. Model Learning: “For each of the dimensions in the dataset, a linear regression model is computed. Therefore we have m=19 linear regression models of the form”:

Ŷ=Xβ.
The model parameter β will be learned from ridge regression. Once the models have been learned, predictive models for business-related targets, such as complaints behavior and the consumption of added-value services, can be built.

The regression computer implement application can be accessed and executed to perform the MPA regression methodology. The steps can include receiving at a computer system an input of data for a matrix, where the matrix is a real-valued data matrix of m row and n columns, and where a real-valued column vector of length m, and a non-negative real-valued penalization weight, and for a given tolerance level ε>0 and an initialization estimation of solution, where the matrix is designed for computing the ridge regression coefficient vector based on the regression formulation; computing the reweight factor, where the solution is the Frobenius norm of matrix A and if the number of columns n is greater than 10³, computing the reweight factor as the estimated Frobenius norm using the power iteration method; if the reweight factor is greater than 1, computing the reweighted data; and repeat the iteration from t=0; computing the reweight factor; and computing reweight factor as the estimated Frobenius norm using the power iteration method, and if the reweight factor is >1, computing the reweighted data.

The various ridge regression examples shown above illustrate a new methodology for ridge regression. A user of the present invention may choose any of the above embodiments, or an equivalent thereof, depending upon the desired application. In this regard, it is recognized that various forms of the subject ridge regression methodology could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the sprit and scope of the present invention.

The various implementations and examples shown above illustrate a method and system for ridge regression of data. A user of the present method and system may choose any of the above implementations, or an equivalent thereof, depending upon the desired application. In this regard, it is recognized that various forms of the subject ridge regression method and system could be utilized without departing from the spirit and scope of the present implementation.

As is evident from the foregoing description, certain aspects of the present implementation are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present implementation. Accordingly, the specification and drawings are to be regarded in an illustrative rather than a restrictive sense.

Certain systems, apparatus, applications or processes are described herein as including a number of modules. A module may be a unit of distinct functionality that may be presented in software, hardware, or combinations thereof. When the functionality of a module is performed in any part through software, the module includes a computer-readable medium. The modules may be regarded as being communicatively coupled. The inventive subject matter may be represented in a variety of different implementations of which there are many possible permutations.

The methods described herein do not have to be executed in the order described, or in any particular order. Moreover, various activities described with respect to the methods identified herein can be executed in serial or parallel fashion. In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine or computing device. Further, while only a single machine is illustrated, the term “machine” shall also be taken to include any collection of machines that individually or jointly execute a set (or multiple sets) of instructions to perform any one or more of the methodologies discussed herein.

The example computer system 100 and client computers 106, 108, 110 include a processor (e.g., a central processing unit (CPU) a graphics processing unit (GPU) or both), a main memory and a static memory, which communicate with each other via a bus. The computer system may further include a video/graphical display unit (e.g., a liquid crystal display (LCD) or a cathode ray tube (CRT)). The computer system 100 and client computing devices 106, 108, 110 also include an alphanumeric input device (e.g., a keyboard), a cursor control device (e.g., a mouse), a drive unit, a signal generation device (e.g., a speaker) and a network interface device.

The drive unit includes a computer-readable medium on which is stored one or more sets of instructions (e.g., software) embodying any one or more of the methodologies or systems described herein. The software may also reside, completely or at least partially, within the main memory and/or within the processor during execution thereof by the computer system, the main memory and the processor also constituting computer-readable media. The software may further be transmitted or received over a network via the network interface device.

The term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present implementation. The term “computer-readable medium” shall accordingly be taken to include, but not be limited to, solid-state memories, and optical media, and magnetic media.

Other aspects, objects and advantages of the present invention can be obtained from a study of the drawings, the disclosure and the appended claims.

What is claimed is:

1. A computer system for ridge regression of data comprising:
a computer having a memory and one or more processors;
one or more programs, stored in the memory and executed by the one or more processors, where the one or more programs include,
instructions for receiving at a computer system an input of data for a matrix where the matrix is a real valued matrix of m rows and n columns, and said matrix having a real-valued column vector y of length m;
instructions for approximating an approximation of the column vector y by linearly combining all columns of the matrix by minimizing an approximation error which is the sum of the squared differences of the approximation and the complexity of the combining coefficients, where minimizing the approximation error further comprises instructions for computing the reweight factor using a power iteration method,
continuing iterating the power iteration method until a convergence stopping criterion is met; and
instructions for storing in the memory an optimal vector for the approximation based on the values of the approximation when the convergence stopping criterion is met.

2. The computer system as recited in claim 1, where the complexity of the combining coefficients is a weighted complexity measure.

3. The computer system as recited in claim 1, where the convergence stopping criterion is met when the Euclidean norm of the difference vector between two consecutive solutions is smaller than the tolerance level.

4. The computer system as recited in claim 1, where the instructions for computing the reweight factor are the Frobenius norm of the matrix using the power iteration method.

5. The computer system as recited in claim 1, where the instructions for the approximating computation involves only matrix-vector multiplications, and the complexity for each iteration is O(mn), and where this method is globally convergent.

6. A non-transitory computer readable storage medium for use in conjunction with a computer system, the computer readable storage medium storing one or more programs including instructions for execution by the computer system, the one or more programs when executed by the computer system cause the computer system to perform operations comprising:
receiving at a computer system an input of data for a matrix where the matrix is a real valued matrix of m rows and n columns, and said matrix having a real-valued column vector y of length m;
approximating an approximation of the column vector y by linearly combining all columns of the matrix by minimizing an approximation error which is the sum of the squared differences of the approximation and the complexity of the combining coefficients, where minimizing the approximation error further comprises instructions for computing the reweight factor using a power iteration method,
continuing iterating the power iteration method until a convergence stopping criterion is met; and
storing in the memory an optimal vector for the approximation based on the values of the approximation when the convergence stopping criterion is met.

7. The computer system as recited in claim 6, where the complexity of the combining coefficients is a weighted complexity measure.

8. The computer system as recited in claim 6, where the convergence stopping criterion is met when the Euclidean norm of the difference vector between two consecutive solutions is smaller than the tolerance level.

9. The computer system as recited in claim 6, where the instructions for computing the reweight factor is the Frobenius norm of the matrix using the power iteration method.

10. The computer system as recited in claim 6, where the instructions for the approximating computation involves only matrix-vector multiplications, and the complexity for each iteration is O(mn), and where this method is globally convergent.

11. A computer system for ridge regression of data comprising:
a computer having a memory and one or more processors;
one or more programs, stored in the memory and executed by the one or more processors, where the one or more programs include,
instructions for receiving at a computer system an input of data for a matrix where the matrix is a real valued matrix of m rows and n columns, and said matrix having a real-valued column vector y of length m and where the data for said matrix is a type of data selected from a group of types of data consisting of signal data, statistical data, and image data;
instructions for approximating an approximation of the column vector y by linearly combining all columns of the matrix by minimizing an approximation error which is the sum of the squared differences of the approximation and the complexity of the combining coefficients, where minimizing the approximation error further comprises instructions for computing the reweight factor using a power iteration method,
continuing iterating the power iteration method until a convergence stopping criterion is met; and
instructions for storing in the memory an optimal vector for the approximation based on the values of the approximation when the convergence stopping criterion is met.

12. The computer system as recited in claim 11, where the complexity of the combining coefficients is a non-negative real-valued penalization weighting factor.

13. The computer system as recited in claim 11, where the convergence stopping criterion is met when the tolerance level of the reweighting factor is not greater than zero.

14. The computer system as recited in claim 11, where the instructions for computing the reweight factor is the Frobenius norm of the matrix using the power iteration method.

15. The computer system as recited in claim 11, where the instructions for the approximating computation involves only matrix-vector multiplications, and the complexity for each iteration is O(mn), and where this method is globally convergent.
